(19) United States
(12) Patent Application Publication
(10) Pub. No.: US 2007/0251052 A1
(43) Pub. Date: Nov. 1, 2007

(54) Buffer for Noise Removal of Closing the Door

(76) Inventor: Chul Soo Pyo, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/578,200

(22) PCT Filed: Nov. 29, 2005
(86) PCT No.: PCT/KR05/04048

§ 371 Date: May 8, 2007

(30) Foreign Application Priority Data
Dec. 2, 2004 (KR) 10-2004-0100462
Nov. 25, 2005 (KR) 10-2005-0113610

(51) Int. Cl. E05F 5/02

(52) U.S. Cl. 16/86 A

(57) ABSTRACT

There is provided a hydraulic damper installed to furniture, such as a sink or wardrobe, for buffering a door. In a buffer for absorbing shock created when a furniture door is closed, the buffer including a cylinder 10 having a cylinder chamber, and a piston 30 inserted in the cylinder chamber, supported by a rod 70 penetrating a packing 60 and a sealing housing 65, and urged by a first resilient spring 40 built in the housing, the buffer includes a pressing bracket 50, mounted to an end of the rod 70, for moving oil in the piston; an oil flow blocking housing 45 mounted to a boss 52 forming an end of the pressing bracket 50 and connected to the first resilient spring 40; and a second resilient spring 55, interposed between the oil flow blocking housing 45 and the pressing bracket 50, for providing the oil flow blocking housing 45 with a return force. Since the hydraulic damper with dual oil passages formed is installed at the closing/opening route of the furniture door, it can minimize a noise generated when the door is closed, regardless of specifications or weight of the door, thereby providing a silent indoor circumstance, regardless of specifications or weight of the door. Further, the door can be smoothly opened or closed, thereby prolonging a life of the hydraulic damper.

### TECHNICAL FIELD

The present invention relates to a hydraulic damper installed to furniture, such as a sink or wardrobe, for buffering a door, and more particularly, to a buffer for absorbing shock created when a furniture door is closed, in which a flow passage of a fluid in a hydraulic damper is modified to minimize a noise generated when the door is closed.

### BACKGROUND ART

In general, a door is installed to cover or protect the objects put in the furniture, and is made of wood or metal.

Wooden doors are generally installed to the furniture, such as a desk, a wardrobe, a sink, or the like, by means of a spring hinge.

Doors are different in shape, depending upon the entire shape of the furniture, but an opening/closing principle of the door by the hinge is identical to every doors. Metal doors are generally installed to front doors or porches, and are configured to sufficiently withstand strong external force applied from the exterior. The metal door is disposed at a position different from the wooden door, but the construction thereof in which the door is opened or closed around the hinge is the same as that of the wooden door.

The open of the door means that corners of the door attached to a frame of the furniture or a wall are detached from the frame or wall. For the metal door, since the noise generated when the door is closed is loud, a hydraulic cylinder is separately installed to the door to minimize the noise. For the wooden door, since the door is light and the noise generated when the door is closed is quieter than that of the metal door, an additional noise buffer is not necessary.

U.S. Pat. No. 6,802,408 discloses a fluid damper operated by a piston and a cylinder, which is shown in FIGS. 1a and 1b.

Specifically, the fluid damper includes a cylinder 1 having a cylinder chamber, a piston 3 linearly movable in the cylinder chamber, urged by a spring 7, and having a number of openings 3a, and a plurality of movable ring disks 8, 9 and 10 disposed at a front side of the piston to cover the opening 3a during a return stroke of the piston.

A piston rod 4 mounted in the cylinder in a longitudinal direction penetrates the piston 3 and the center portions of the ring disks 8, 9 and 10. A guide 22 is coupled to the piton rod 4 by means of a connecting rod 21, and is moved front and rear by the urging force of the spring 7 to compress or uncompress the oil therein. In particular, the ring disks 8, 9 and 10 are mounted to the coupling rod 21.

In case external force is applied to the fluid damper, the spring 7 is compressed by the guide 22 to a degree corresponding to the external force applied to the piston 3. Thus, the oil in the cylinder 1 flows through the opening 3a of the piston 3 and the oil holes 15 of the ring disks 8, 9 and 10 to buffer the external force.

In contrast, in case external force is released from the fluid damper, the guide 22 is returned to its original position, and the oil in the cylinder 1 is returned through the oil holes 15 of the ring disks 8, 9 and 10 and the opening 3a of the piston 3. Simultaneously, the ring disks 8, 9 and 10 seal the opening 3a of the piston 3.

The fluid damper of the U.S. patent has a problem in that when the fluid damper is installed to a furniture part, it is spaced apart from a rim of the door at a given interval.

Specifically, the ring disks 8, 9 and 10 installed to the front side of the piston 3 are manufactured to have a diameter slightly smaller than an inner diameter of the cylinder 1, in view of a shock amount created when the door is closed. When the opening 3a is closed by the ring disks 8, 9 and 10, the oil flows through a gap 23 between the cylinder 1 and the piston 3.

Accordingly, in order to quickly return the fluid damper and provide sufficient damping force, the resiliency of the spring 7 should be increased.

If the resiliency of the spring 7 is increased, the fluid damper may be used in a large and heavy door. When it is used in a small or light door, the door is always opened at a given interval by the restoring force of the spring 7.

Further, if the spring 7 is made of material having a low elastic modulus so as to increase a contact degree of the door, the gap 23 between the cylinder 1 and the ring disks 8, 9 and 10 should be enlarged to quickly return the piston 3. Therefore, the fluid damper cannot properly absorb excessive load applied to the fluid damper from the exterior.

### DISCLOSURE OF INVENTION

Technical Problem

Therefore, an object of the present invention is to solve the problems involved in the prior art, and to provide a buffer for absorbing shock created when a furniture door is closed, in which a flow passage of a fluid in a hydraulic damper is modified to minimize a noise generated when the door is closed.

Another abject of the present invention is to provide a buffer for a door which can easily absorb excessive shock applied to the door and be installed to the door, regardless of specifications or weight of the door.

Technical Solution

In order to achieve these and other objects, the present invention provides a buffer for absorbing shock created when a furniture door is closed, the buffer including a cylinder having a cylinder chamber, and a piston inserted in the cylinder chamber, supported by a rod penetrating a packing and a sealing housing, and urged by a first resilient spring built in the housing, comprising: a pressing bracket, mounted to an end of the rod, for moving oil in the piston; an oil flow blocking housing mounted to a boss forming an end of the pressing bracket and connected to the first resilient spring; and a second resilient spring, interposed between the oil flow blocking housing and the pressing bracket, for providing the oil flow blocking housing with a return force.

Advantageous Effects

With the above description, according to the buffer of the present invention, since the hydraulic damper with dual oil passages formed is installed at the closing/opening route of the furniture door, it can minimize a noise generated when the door is closed, regardless of specifications or weight of the door, thereby providing a silent indoor circumstance, regardless of specifications or weight of the door. Further, the door can be smoothly opened or closed, thereby prolonging a life of the hydraulic damper.

### BRIEF DESCRIPTION OF THE DRAWINGS

FIGS. 1a and 1b are cross-sectional views of a conventional buffer for furniture doors.

FIG. 2 is an exploded cross-sectional view illustrating a rod fixed to a cylinder of a buffer door according to an embodiment of the present invention.

FIG. 3 is an exploded cross-sectional view illustrating a buffer according to an embodiment of the present invention.

FIG. 4 is a cross-sectional view illustrating a free state of a buffer according to an embodiment of the present invention.

FIG. 5 is a cross-sectional view illustrating the state external force is applied to a buffer, according to an embodiment of the present invention.

FIG. 6 is a cross-sectional view and a partially enlarged view illustrating the state external force is applied to the buffer shown in FIG. 4.

FIG. 7 is a cross-sectional view and a partially enlarged view illustrating the state external force is released from the buffer shown in FIG. 5.

FIG. 8 is a perspective view illustrating major parts of a buffer according to the present invention.

FIG. 9 is a perspective view illustrating the installed state of a buffer according to an embodiment of the present invention.

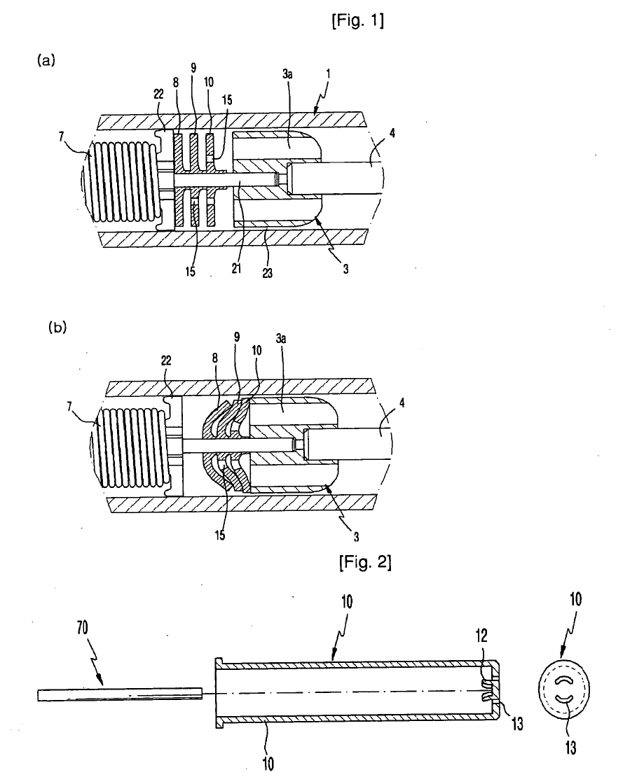

### BEST MODE FOR CARRYING OUT THE INVENTION

Reference will now be made in detail to preferred embodiments of the present invention, examples of which are illustrated in the accompanying drawings.

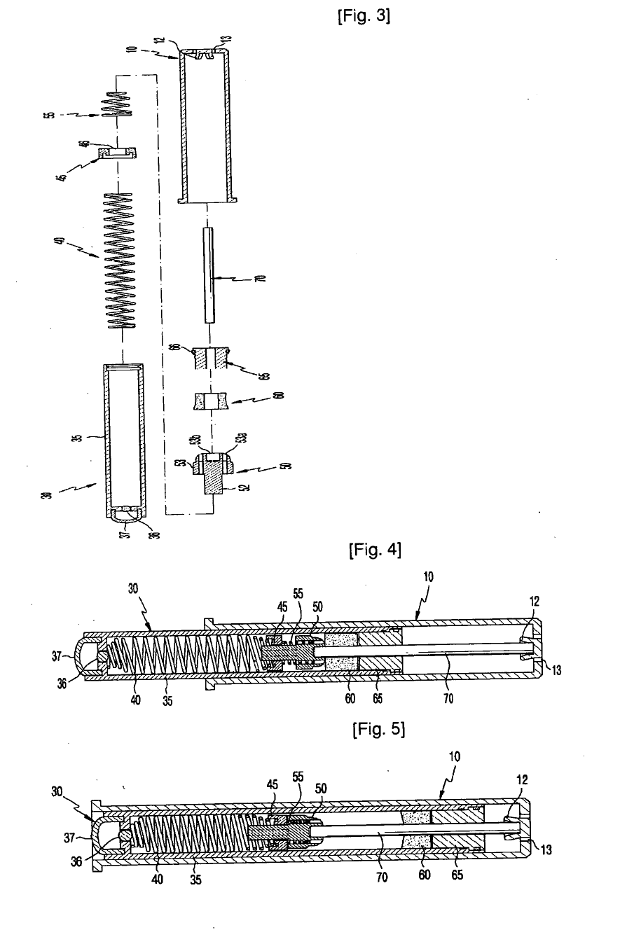

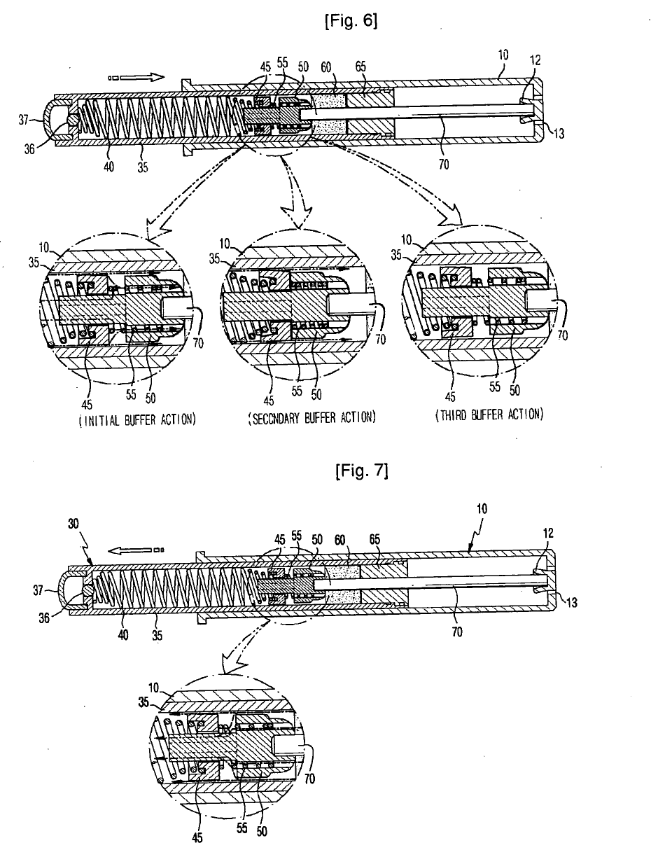

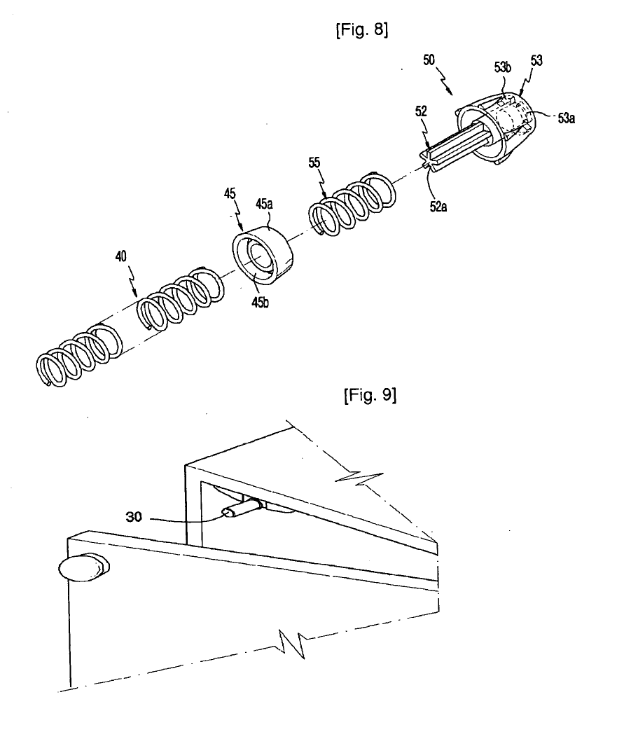

FIG. 2 is an exploded cross-sectional view illustrating a rod fixed to a cylinder of a buffer door according to an embodiment of the present invention. FIG. 3 is an exploded cross-sectional view illustrating a buffer according to an embodiment of the present invention. FIG. 4 is a cross-sectional view illustrating a free state of a buffer according to an embodiment of the present invention. FIG. 5 is a cross-sectional view illustrating the state external force is applied to a buffer, according to an embodiment of the present invention. FIG. 6 is a cross-sectional view and a partially enlarged view illustrating the state external force is applied to the buffer shown in FIG. 4. FIG. 7 is a cross-sectional view and a partially enlarged view illustrating the state external force is released from the buffer shown in FIG. 5. FIG. 8 is a perspective view illustrating major parts of a buffer according to the present invention. FIG. 9 is a perspective view illustrating the installed state of a buffer according to an embodiment of the present invention.

A buffer for absorbing shock created when a furniture door is closed, the buffer including a cylinder 10 having a cylinder chamber, and a piston 30 inserted in the cylinder chamber, supported by a rod 70 penetrating a packing 60 and a sealing housing 65, and urged by a first resilient spring 40 built in the housing, comprises a pressing bracket 50, mounted to an end of the rod 70, for moving oil in the piston, an oil flow blocking housing 45 mounted to a boss 52 forming an end of the pressing bracket 50 and connected to the first resilient spring 40, and a second resilient spring 55, interposed between the oil flow blocking housing 45 and the pressing bracket 50, for providing the oil flow blocking housing 45 with a return force.

As shown in the accompanying drawings, the buffer according to an embodiment of the present invention includes a cylinder 10 and a piston 30.

The cylinder 10 is made of a synthetic resin having given hardness, and has an opened side to form a storage space therein. As shown in FIG. 2, the cylinder 10 is formed with a rod fixing boss 12 on an inner surface thereof. The rod fixing boss 12 is formed with a pair of through-holes 13 around a center portion of a bottom of the cylinder. When forming the cylinder 10, a forming pin (not shown) is inserted in the through-hole 13, and an end surface of the cylinder 10 is pushed up.

The rod fixing boss 12 protrudes from the inside of the cylinder 10 in the same shape, with an upper end portion having a diameter larger than that of a lower end portion.

The piston 30 is inserted into the cylinder 10 configured as described above. The piston 30 includes an outer case 35, a first resilient spring 40, an oil flow blocking housing 45, a pressing bracket 50, a second resilient spring 55, a packing 60, a sealing housing 65, and a rod 70.

As shown in FIG. 3, the outer case 35 is formed in a tube having both opened ends. The outer case 35 is filled with oil, and one end portion of the outer case is provided with a closing ball 36 so as to prevent leakage of the oil. A bumper 37 is engaged to the end portion of the outer case at a rear of the closing ball 36.

The first resilient spring 40 is inserted in the outer case 35. The first resilient spring 40 has a good resilient restoring force, and a diameter of the first resilient spring is smaller than an inner diameter of the outer case 35 so that there is no friction between the first resilient spring 40 and the outer case 35 when the first resilient spring is compressed or released.

The first resilient spring 40 is inserted in the outer case 35 together with the oil flow blocking housing 45 made of soft rubber, with the housing being closely contacted the first resilient spring 40. The oil flow blocking housing 45 has a diameter so that it does not contact an inner surface of the outer case 35. The oil flow blocking housing 45 is formed with a through-hole 46 at the center portion thereof.

The end portion of the first resilient spring 40 is inserted into the oil flow blocking housing 45 by a desired length, and is made in a peaked hat shape in general. That is, the oil flow blocking housing 45 has a taper shape so that a diameter is decreased towards the end opposite to the portion receiving the end of the first resilient spring 40.

Specifically, the pressing bracket 50 is inserted in the oil flow blocking housing 45, with the pressing bracket 50 being accommodated in the outer case 35. The pressing bracket 50 consists of a boss 52 and a cap 53. The boss 52 has an outer surface of a serration shape. The boss 52 is formed in a bar shape having several vertexes like a star, and is inserted into the through-hole 46 of the oil flow blocking housing.

As shown in FIG. 8, the oil flow blocking housing 45 has a storage space 45b for receiving one end of the first resilient spring 40. The storage space 45b is provided on a periphery surface thereof with a curtain portion 45a expanded/retracted by external shock to contact or detach from the inner wall of the piston 30.

Also, as shown in FIG. 8, the pressing bracket 50 is integrally formed with the bosses 52 on which the oil flow blocking housing 45 is slidably mounted and the cap 53. An oil passing space 52a is formed between the bosses 52, and the cap 53 is formed with oil flow ports 53a communicating with the oil passing space 52a and an engaging groove 53b to which the rod 70 is engaged.

Specifically, the cap 53 is integrally extended from the boss 52. The cap 53 partially covers the outer surface of the boss 52, and is formed with a plurality of oil flow ports 53a on the outer periphery surface thereof. Further, the cap 53 is formed with the engaging groove 53b.

In this case, the boss 52 inserted in the oil flow blocking housing 45 passes through the second resilient spring 55.

The second resilient spring 55 has a length shorter than that of the first resilient spring 40, and a resilient restoring force lower than that of the first resilient spring 40. In the state both end portions of the second resilient spring 55 are interposed between the oil flow blocking housing 45 and the pressing bracket 50, i.e., the boss 52 of the pressing bracket 50 is inserted into the second resilient spring 55, the end of the second resilient spring 55 contacts the oil flow blocking housing 45.

The packing 60 and the sealing housing 65 are sequentially accommodated and secured in the outer case 35.

The packing 60 is made of a material such as a sponge, and is closely contacted or detached from the pressing bracket 50 according to the movement of the oil flow blocking housing 45 and the pressing bracket 50.

The sealing housing 65 is installed to prevent the leakage of the oil filled in the outer case 35, with the sealing housing 65 being closely contacting the packing 60. An O-ring is disposed on the outer periphery surface of the sealing housing 65 so as to maintain strong sealing force.

The rod 70 is connected to the engaging groove 53b of the pressing bracket through the center portions of the sealing housing 65 and packing 60 in the outer case 35. The rod 70 is formed in a pin shape of a metal material having good corrosion resistance.

One end of the rod 70 is fixed to the engaging groove 53b of the pressing bracket 50, and the other end is fixed to the rod fixing boss 12 of the cylinder.

The operation of the buffer according to the present invention will now be described with reference to the accompanying drawings.

First, as shown in FIG. 9, when the door D of the furniture or sink with the buffer is closed, the door D strikes the bumper 37 of the piston, and the shock of the door D is transferred to the piston through the bumper 37.

In this case, the first resilient spring 40 is compressed by the oil flow blocking housing 45, the second resilient spring 55, and the pressing bracket 50 connected to the rod 70, so that the piston 30 is inserted to a distance corresponding to the shock wave applied to the bumper 37.

Thus, as the initial stage of FIG. 6, the oil in the piston 30 flows through the oil passing space 52a of the pressing bracket 50 and the space between the inner periphery of the piston 30 and the oil flow blocking housing 45, as indicated by arrow.

Then, the oil passing the oil flow blocking housing 45 flows through the oil flow ports 53a of the pressing bracket 50 and the space between the inner periphery of the piston 30 and the pressing bracket 50, as indicated by arrow.

Meanwhile, as shown in FIG. 6, in case the oil flow blocking housing 45 closely contacts the pressing bracket 50 while the piston 30 is inserted, the oil passage formed in the center portion of the oil flow blocking housing 45 is sealed.

Hence, the oil in the piston 30 flows through the space between the inner periphery of the piston 30 and the oil flow blocking housing 45, or the space between the inner periphery of the piston 30 and the pressing bracket 50.

Further, since the curtain portion 45a of the oil flow blocking housing 45 is widened and closely contacts the inner wall of the piston 30, in the course of oil flow, the space between the inner periphery of the piston 30 and the oil flow blocking housing 45 is sealed and interrupted.

The shock wave applied to the bumper 37 is eliminated by the flow of the oil, and for example, when the piston 30 is returned by the resilient force of the first spring 40, the oil flow blocking housing 45 is pushed by the second resilient spring 55.

Thus, the oil flow blocking housing 45 closely contacting the pressing bracket 50 is spaced apart from the pressing bracket 50, and the oil staying at the rear side of the pressing bracket 50 may be returned via the pressing bracket 50.

Specifically, as shown in FIG. 7, the oil of the piston 30 flows through the oil passing space 52a of the pressing bracket 50 or the space between the inner periphery of the piston 30 and the pressing bracket 50 to return to the oil flow blocking housing 45 and the first spring 40.

Further, since the curtain portion 45a of the oil flow blocking housing 45 is shrunk, the oil quickly passes the space between the inner periphery of the piston 30 and the oil flow blocking housing 45.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. A buffer for absorbing shock created when a furniture door is closed, the buffer including a cylinder 10 having a cylinder chamber, and a piston 30 inserted in the cylinder chamber, supported by a rod 70 penetrating a packing 60 and a sealing housing 65, and urged by a first resilient spring 40 built in the housing, comprising:
a pressing bracket 50, mounted to an end of the rod 70, for moving oil in the piston; an oil flow blocking housing 45 mounted to a boss 52 forming an end of the pressing bracket 50 and connected to the first resilient spring 40; and a second resilient spring 55, interposed between the oil flow blocking housing 45 and the pressing bracket 50, for providing the oil flow blocking housing 45 with a return force.

2. The buffer as claimed in claim 1, wherein the oil flow blocking housing 45 has a storage space 45b for receiving one end of the first resilient spring 40, and the storage space 45b is provided on a periphery surface thereof with a curtain portion 45a expanded/retracted by external shock to contact or detach from an inner wall of the piston 30.

3. The buffer as claimed in claim 1, wherein the pressing bracket 50 is integrally formed with bosses 52, on which the oil flow blocking housing 45 is slidably mounted, and a cap 53, an oil passing space 52a is formed between the bosses 52, and the cap 53 is formed with oil flow ports 53a communicating with the oil passing space 52a and an engaging groove 53b to which the rod 70 is engaged.
